(19) United States
(12) Patent Application Publication
(10) Pub. No.: US 2017/0017643 A1
(43) Pub. Date: Jan. 19, 2017

(54) TRANSLATION OF LOCALE SPECIFIC TEXT INTO ANOTHER LANGUAGE

(71) Applicant: International Business Machines Corporation, Armonk, NY (US)

(72) Inventors: Gavin G. Bray, Robina (AU); Chia-Le Cheng, Sunnybank (AU); Kalvinder P. Singh, Miami (AU)

(21) Appl. No.: 14/798,586

(22) Filed: Jul. 14, 2015

(51) Int. Cl. G06F 17/28

(52) U.S. Cl. CPC G06F 17/2845

(57) ABSTRACT

In a method for translating text into another language, receiving, by one or more processors, text in a first language. Comparing, by one or more processors, the text to a plurality of resource bundle strings in the first language. Determining, by one or more processors, that the text at least partially matches one or more resource bundle strings of the plurality of resource bundle strings. Determining, by one or more processors, a resource bundle key corresponding to each resource bundle string of the one or more resource bundle strings. Translating, by one or more processors, the text from the first language to a second language using one determined resource bundle key.

### BACKGROUND OF THE INVENTION

The present invention relates generally to the field of computer software, and more particularly to text translation computer software.

Internationalization is the process of designing a software application so that it can potentially be adapted to various languages and regions without engineering changes. The current prevailing practice is for software applications to place text in resource strings, which are loaded during program execution as needed. These strings, stored in resource files, are relatively easy to translate. Programs are often designed to reference resource libraries depending on the selected locale data. Thus, to get an application to support multiple languages, one would design the application to select the relevant language resource file at runtime. Resource files are translated to the required languages. This method tends to be application-specific and, at best, vendor-specific.

A resource bundle is a file that contains locale-specific data (objects). It is a way of internationalizing an application by making the code locale-independent. Extracting locale-sensitive objects such as strings from the code (as opposed to hard-coding them) means that the application can handle multiple locales without having to write different code for each locale. When a program needs a locale-specific resource, a string for example, the program can load it from the resource bundle that is appropriate for the current user's locale. As a result, program code can be written largely independent of the user's locale isolating most, if not all, of the locale-specific information in resource bundles.

### SUMMARY

Aspects of the present invention disclose a method, computer program product, and a system for translating text into another language. The method includes receiving, by one or more processors, text in a first language. The method further includes comparing, by one or more processors, the text to a plurality of resource bundle strings in the first language. The method further includes determining, by one or more processors, that the text at least partially matches one or more resource bundle strings of the plurality of resource bundle strings. The method further includes determining, by one or more processors, a resource bundle key corresponding to each resource bundle string of the one or more resource bundle strings. The method further includes translating, by one or more processors, the text from the first language to a second language using one determined resource bundle key.

### BRIEF DESCRIPTION OF THE DRAWINGS

FIG. 1 depicts a functional block diagram illustrating a computing environment, in accordance with an embodiment of the present invention;

FIG. 2 depicts a flowchart of operational steps of a translation program translating locale-specific text into another language, in accordance with an embodiment of the present invention; and

FIG. 3 is a block diagram of components of the server and client computing device of FIG. 1, in accordance with an embodiment of the present invention.

### DETAILED DESCRIPTION

Embodiments of the present invention recognize the difficulty technical support personnel may face when viewing text from log files and/or screenshots in a foreign language. Embodiments of the present invention allow for translating text from log files and screenshots. The text of the screenshot and/or log file will be in the local language of a user.

The present invention will now be described in detail with reference to the Figures.

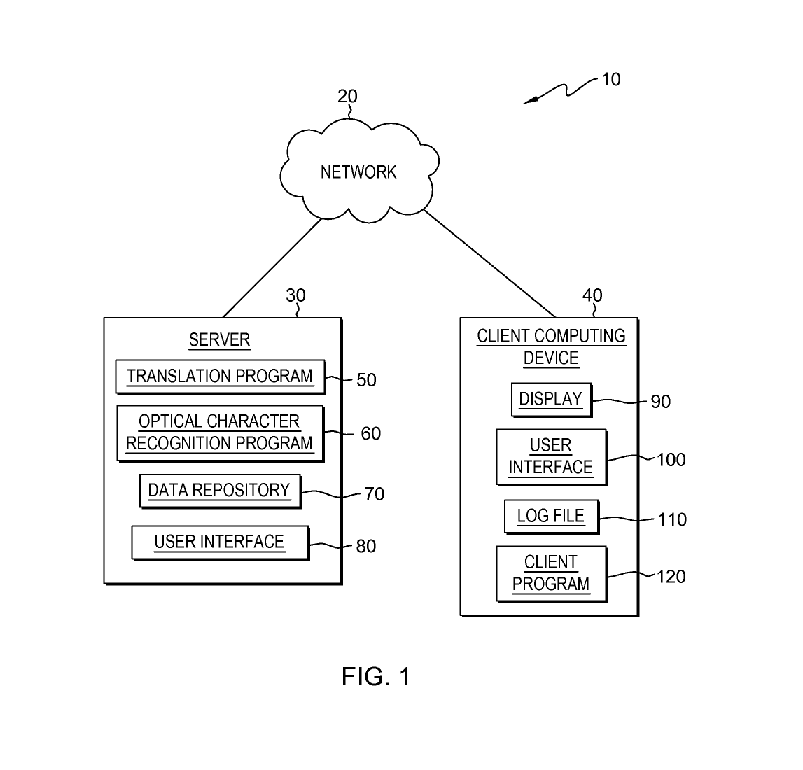

FIG. 1 depicts a diagram of computing environment 10 in accordance with one embodiment of the present invention. FIG. 1 provides an illustration of one embodiment and does not imply any limitations with regard to the environments in which different embodiments may be implemented.

In the depicted embodiment, computing environment 10 includes server 30 and client computing device 40 interconnected over network 20. Network 20 may be a local area network (LAN), a wide area network (WAN) such as the Internet, any combination thereof, or any combination of connections and protocols that will support communications between server 30 and client computing device 40 in accordance with embodiments of the present invention. Network 20 may include wired, wireless, or fiber optic connections. Computing environment 10 may include additional computing devices, servers, or other devices not shown.

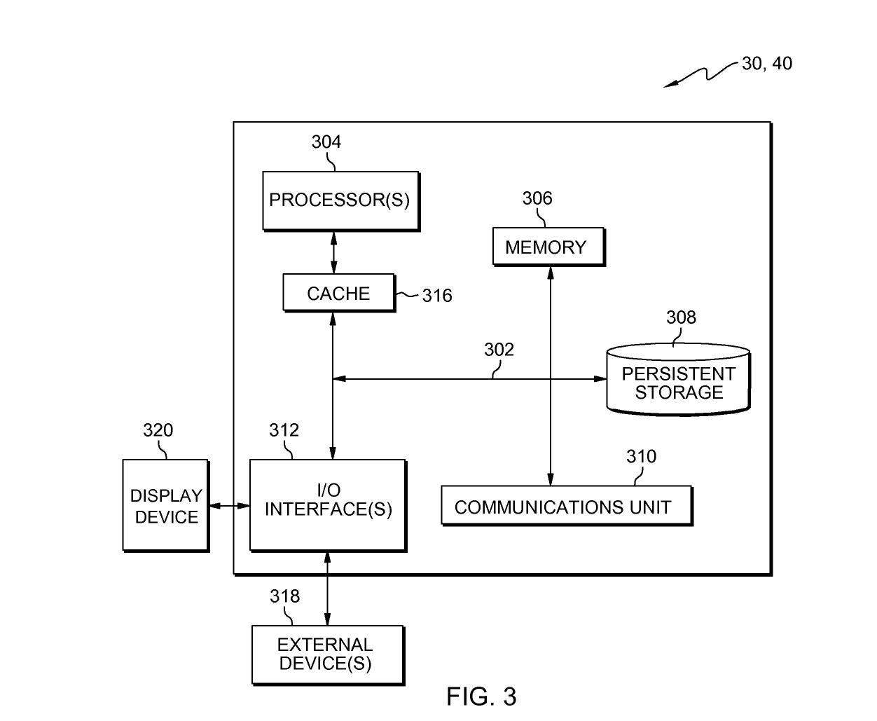

Server 30 may be a management server, a web server, or any other electronic device or computing environment capable of processing computer readable program instructions, and receiving and sending data. In other embodiments, server 30 may be a laptop computer, tablet computer, netbook computer, personal computer (PC), a desktop computer, or any programmable electronic device capable of communicating with client computing device 40 via network 20. In other embodiments, server 30 may represent a server computing environment utilizing multiple computers as a server system, such as in a cloud computing environment. In another embodiment, server 30 represents a computing environment utilizing clustered computers and components to act as a single pool of seamless resources. In one embodiment, server 30 contains translation program 50, optical character recognition (OCR) program 60, data repository 70, and user interface (UI) 80. Server 30 may include components as depicted and described in further detail with respect to FIG. 3.

OCR program 60 operates to convert images of typewritten or printed text into machine-encoded text. In one embodiment, OCR program 60 uses electronic methods for converting the images into machine-encoded (digitized) text. The digitized text can be electronically edited, searched, stored more compactly, displayed online, and used in machine processes such as machine translation, text-to-speech, key data, and text mining. In one embodiment, OCR program 60 targets typewritten text, one glyph or character at a time. In another embodiment, OCR program 60, while using optical word recognition, targets typewritten text, one word at a time (for languages that use a space as a word divider). In some embodiments, OCR program 60 resides on server 30. In other embodiments, OCR program 60 may reside on another server, or another computing device, provided that OCR program 60 is accessible to translation program 50.

Translation program 50 operates to translate text from log files and screenshots. In one embodiment, translation program 50 translates text from one language to a different language using resource bundle keys. Translation program 50 translates text originating from log files and screenshots. For example, a user in France receives an error message pop-up. The French user sends a screenshot of the error message pop-up to a German technical support team. Translation program 50 translates the French text to German. The translation of the French text to German allows the German technical support team to assist the French user. In one embodiment, translation program 50 searches the resource bundle corresponding to the language of the log file and/or screenshot text for the closest matching resource bundle string. The resource bundle string corresponds to a resource bundle key.

In one embodiment, translation program 50 determines if the closest matching string is a literal string or a template string. A literal string does not include substitution parameters. A template string includes at least one substitution parameter. The substitution parameter is a variable that can change (e.g., a username or a file name). A substitution parameter uses characters to specify placeholders within a template string. A substitution substring replaces the substitution parameter in the template string. For example, “{0} esiste gia. Sostituirlo?” is a template string. “{0}” is the substitution parameter. “/myfile” is identified as the substitution parameter value that is inserted into the template string replacing the substitution parameter “{0}”. When the “{0}” substitution parameter is replaced with the “/myfile” value, the string becomes “/myfile esiste gia. Sostituirlo?”.

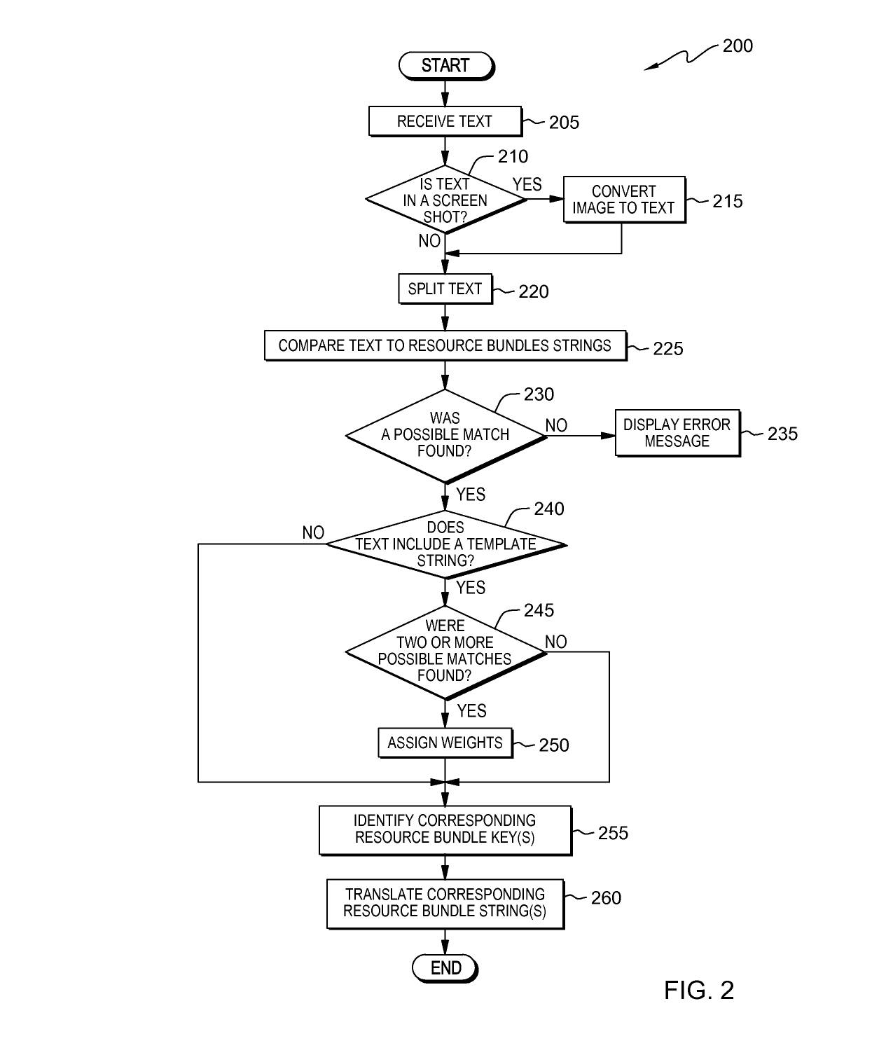

In one embodiment, translation program 50 uses an approximate string matching algorithm and/or regular expressions (details provided in FIG. 2) to identify the potential template resource bundle string(s). In one embodiment, translation program 50 assigns weighted values to further refine results if more than one string is a potential match. Translation program 50 uses contextual information of text in the vicinity of the received text from the log file and/or screenshot.

The shorter the distance between strings that are a potential match and resource bundle strings, the higher the weighted value translation program 50 assigns to the potential match. For example, the string with the highest weighted value is the correct string match. In one embodiment, to translate the text, translation program 50 identifies the correct resource bundle key (details provided in FIG. 2) based on the weighted values of the strings that are potential matches.

In one embodiment, data repository 70 is a repository that may be written to and/or read by translation program 50. In one embodiment, data repository 70 stores data such as, but not limited to, resource bundle files (resource bundles). In one embodiment, data repository 70 stores locale-specific resource bundle files in their respective languages. In one embodiment, data repository 70 stores a library of resource bundle files including, but not limited to, the resource bundle files of client program 120. Each resource bundle file contains resource bundle key/value pairs. The keys, which are strings, uniquely identify a locale-specific value (object) in the bundle. A string is traditionally a sequence of characters, either as a literal constant or as some kind of variable. A string is generally understood as a data type and is often implemented as an array of bytes (or words) that stores a sequence of elements, typically characters, using some character encoding. A string may also denote more general arrays or other sequence (or list) data types and structures.

For example, when a program requests a locale-specific resource, a string for example, the program loads the locale-specific resource (a string in this example) from the resource bundle that is appropriate for the current user's locale. In some embodiments, data repository 70 stores log messages from log file 110.

In some embodiments, data repository 70 resides on server 30. In other embodiments, data repository 70 may reside on another server, or another computing device, provided that data repository 70 is accessible to translation program 50.

UI 80 operates on server 30 to visualize content, such as menus and icons, and to allow a user to interact with an application accessible to server 30. In one embodiment, UI 80 comprises an interface to translation program 50. UI 80 may display data received from translation program 50 and send input to translation program 50. In other embodiments, UI 80 may comprise one or more interfaces such as, an operating system interface and/or application interfaces. In example embodiments, a user (through input via UI 80) of server 30 communicates with translation program 50.

Client computing device 40 may be a desktop computer, laptop computer, tablet computer, personal digital assistant (PDA), or smart phone. In general, client computing device 40 may be any electronic device or computing system capable of executing computer readable program instructions, and communicating with server 30 over network 20. In one embodiment, client computing device 40 contains display 90, UI 100, log file 110, and client program 120. Client computing device 40 may include components, as depicted and described in further detail with respect to FIG. 3.

Display 90 provides a mechanism to display data to a user and may be, for example, a computer monitor, or a smart phone display screen. In some embodiments, display 90 is a component of client computing device 40. In other embodiments, display 90 may be an external component of client computing device 40 connected to client computing device 40.

UI 100 operates on client computing device 40 in combination with display 90 to visualize content, such as menus and icons, and to allow a user to interact with an application accessible to client computing device 40. In one embodiment, UI 100 comprises an interface to client program 120. UI 100 may display data received from client program 120 and send input to client program 120. In other embodiments, UI 100 may comprise one or more interfaces such as, an operating system interface and/or application interfaces. In example embodiments, a user (through input via UI 100) of client computing device 40 communicates with client program 120.

Log file 110 may be a data file that contains content generated by client program 120. Log file 110 may be written and read by translation program 50 and client program 120. In one embodiment, log file 110 is located on client computing device 40. In another embodiment, log file 110 may be located on another server or another computing device, provided that log file 110 is accessible to translation program 50 and client program 120.

Client program 120 operates as a generic program on client computing device 40. In one embodiment, client program 120 generates and writes content to log file 110. The content may be generated from different functions or methods within client program 120. In one embodiment, the content may include log messages. The log messages may be any text string with contextual information. In another embodiment, client program 120 generates error messages in UI 100. For example, the error message could be in the form of a pop-up in UI 100. In one embodiment, client program 120 includes resource bundle files. In one embodiment, client program 120 includes locale-specific resource bundle files in their respective languages. For example, client program 120 includes a resource bundle file for each of the following languages: English, French, Spanish, German, Italian, Korean, Japanese, and Arabic. In one embodiment, each resource bundle file has corresponding resource bundle strings to resource bundle strings in resource bundles of another language. For example, the French and English resource bundles of client program 120 have corresponding resource bundle strings translated in their respective languages. In one embodiment, client program 120 resides on client computing device 40. In another embodiment, client program 120 resides on another server or another computing device, provided that client program 120 has access to log file 110.

FIG. 2 depicts a flowchart of operational steps 200 of translation program 50 executing within the computing environment of FIG. 1, in accordance with an embodiment of the present invention. Translation program 50 operates to translate text of a log message, or an error message, using an associated resource bundle key. In one embodiment, the steps of the workflow are performed by translation program 50. Alternatively, steps of the workflow can be performed by any other program while working with translation program 50.

In one embodiment, initially, a user at client computing device 40, through input via UI 100, opens client program 120. When an error occurs within client program 120, the user, through UI 100, receives an error message or a log message displayed on display 90. In one embodiment, the user contacts a technical support team that speaks a different language than the language the error message or log message was written in. The user sends the error message or log message to the technical support team. The technical support team uses, through UI 80, translation program 50 to translate the error message or log message. Once the error message or log message is translated to the language of the technical support team, the technical support team can assist the user with the error message or log message generated by client program 120.

In step 205, translation program 50 receives text to be translated. In one embodiment, client program 120 automatically sends log messages or error messages to translation program 50 over network 20. In another embodiment, a user, through input via UI 100, sends log messages or error messages to translation program 50 over network 20. In other embodiments, translation program 50 sends a request to client program 120 for log messages or error messages generated by client program 120. Translation program 50 can receive machine-encoded text or images of typewritten text. For example, a French user receives an error message in the form of a pop-up in UI 100. Upon the user receiving the error message, client program 120 automatically sends a screenshot of the error message to translation program 50 of a technical support team in Germany.

In determination step 210, translation program 50 determines if the received text is in a screenshot. In one embodiment, translation program 50 determines whether the received text is in a screenshot based on the file format of the received file containing the text. For example, translation program 50 determines that the received file containing the text has a “.jpeg” file extension, therefore, the text is in a screenshot. “.jpg”, “.bmp”, “.tiff”, and “.png” are examples of alternative image file formats. For example, translation program 50 determines that received text with a “.log” extension is machine-encoded text of a log message, not an image of typewritten text. “.txt” and “.doc” are examples of alternative machine-encoded text file formats. If translation program 50 determines that the received text is a screenshot, processing proceeds down the “Yes” branch to step 215.

In step 215, translation program 50 converts screenshot images of typewritten text into machine-encoded text. In one embodiment, translation program 50 sends an image of typewritten text to OCR program 60 for processing. OCR program 60 converts the image of typewritten text to machine-encoded text. For example, a screenshot (with a “.jpg” file extension) of an error message pop-up is sent to translation program 50 to be converted to machine-encoded text in the form of a “.txt” file extension. Once the image of typewritten text is converted to machine-encoded text, OCR program 60 sends the converted results to translation program 50. Once translation program 50 receives the converted results from OCR program 60, processing proceeds to step 220.

If translation program 50 determines that the text received is not in a screenshot, processing proceeds down the “No” branch to step 220. In step 220, translation program 50 splits text into appropriate sections. In one embodiment, translation program 50 splits text at newlines (e.g. the end of a line of text). For example, translation program 50 splits text at the end of each sentence.

In step 225, translation program 50 compares the received text to the resource bundle strings. In one embodiment, translation program 50 compares the text received to the resource bundle strings located within the resource bundle of client program 120. Translation program 50 searches the resource bundle of client program 120 for the resource bundle string(s) that most closely matches the text received from log file 110. For example, if the received text is “You must specify a valid file,” translation program 50 searches the resource bundle for a resource bundle string that resembles the received text. In one embodiment, translation program 50 searches for resource bundle strings that include a majority of the characters that are in the received text. In another embodiment, translation program 50 searches the resource bundle for strings that include all of the characters that are in the received text. In one embodiment, translation program 50 searches resource bundles stored in data repository 70 for resource bundle strings that closely match the received text. In another embodiment, translation program 50 searches resource bundles stored in data repository 70 for a resource bundle string that is an exact match to the received text.

In one embodiment, translation program 50 compares the resource bundle strings of client program 120 to the received text by using an approximate string matching algorithm such as the Levenshtein distance metric. Approximate string matching is a technique used to locate strings that match a pattern approximately, rather than exactly. Generally, short strings are searched for within longer text in which a small number of differences is to be expected. Typically, the Levenshtein distance between two sequences/texts is the minimum number of single-character edits (e.g., insertions, deletions, or substitutions) required to change one sequence/text into the other sequence/text. The fewer the substitutions, the closer the match. For example, there is a shorter Levenshtein distance between “cat” and “bat” than “cat” and “gap”. There is a single-character edit between “cat” and “bat.” Whereas, there is a two character edit between “cat” and “gap”.

In another embodiment, translation program 50 uses regular expressions to identify the corresponding resource bundle string(s). Translation program 50 converts the resource bundle strings into regular expressions by replacing substitution parameters with a symbol representing a sequence of characters. For example, the resource bundle string “{0} esiste gia. Sostituirlo?” is converted into the regular expression “.* esiste gia. Sostituirlo?” where “.*” represents “{0}”. In one embodiment, translation program 50 selects the resource bundle string(s) that most closely resembles the received text.

In determination step 230, translation program 50 determines if at least one potential match was found. In one embodiment, translation program 50 determines if at least one potential match was found by analyzing the comparison of the received text to the potential corresponding resource bundle string(s). For example, if translation program 50 finds there is little variation between the sequence of characters of the received text and the sequence of characters of the potential corresponding string(s), within a pre-determined range, translation program 50 determines that a potential match was found.

In one embodiment, translation program 50 analyzes the comparison of the received text to the potential corresponding resource bundle string(s) by utilizing approximate string matching. For example, the shorter the Levenshtein distance between two sequences, the greater the likelihood a match was found. In other embodiments, translation program 50 analyzes the comparison of the received text to the potential resource bundle string by utilizing regular expressions. For example, translation program 50 selects the longest regular expression as a possible match since there are more literal characters than wildcards in a longer regular expression as opposed to a shorter regular expression with fewer literal characters and a greater number of characters that are variables. If translation program 50 determines a potential match was found, processing proceeds down the “Yes” branch to determination step 240.

If translation program 50 determines there is not a potential match, processing proceeds down the “No” branch to step 235. In step 235, translation program 50 displays an error message. In one embodiment, if no match is found within a determined Levenshtein distance/range using approximate string matching, translation program 50 displays an error message in UI 80 to inform the user, and/or technical support team, that no match was found. In another embodiment, translation program 50 sends an indication to client program 120 of the error. Processing ends once the user, and/or technical support team, is informed no match was found.

In determination step 240, translation program 50 determines if the text includes a template string. In one embodiment, translation program 50 determines the received text consists of template text based on substitution parameters. Template text is a string that contains at least one substitution parameter. A substitution parameter uses characters to specify placeholders within a template string. Template text allows substitution substrings to replace a character string with another value. Substitution substrings are what replaces substitution parameters in a template string. For example, “{0} esiste gia. Sostituirlo?” is the template text. “{0}” is a substitution parameter for “/myfile”. Translation program 50 recognizes that a symbol such as “{0}” denotes a substitution parameter. If the text doesn't include substitution substrings, it's not a template string. If the text is not a template string (i.e. no substitution substrings), it is an exact match. The potential matching string(s) will either be a template string or an exact matching string. In one embodiment, translation program 50 recognizes substitution parameters within a string and knows as a result of seeing the substitution parameter that the string is a template string. If translation program 50 determines the text does not consist of template text and at least one substitution substring, processing proceeds down the “No” branch to step 255.

If translation program 50 determines the text does consist of template text, processing proceeds down the “Yes” branch to determination step 245. In determination step 245, translation program 50 determines if more than one resource bundle string of client program 120 is a potential match. In one embodiment, translation program 50 searches the resource bundle of client program 120 to determine if more than one resource bundle string is a potential match by locating the string(s) with the lowest Levenshtein distance. In another embodiment, translation program 50 searches the resource bundle of data repository 70 to determine if more than one resource bundle string is a potential match by locating the string(s) with the lowest Levenshtein distance. If more than one string has the lowest number, more than one string is a potential match. For example, translation program 50 identified a distance of two as the lowest Levenshtein distance generated between the resource bundle strings and the received text. Translation program 50 identified three resource bundle strings that each have a Levenshtein distance of two. Therefore, more than one resource bundle string is a potential match to the received text.

In another embodiment, translation program 50 searches the corresponding resource bundle to determine if more than one resource bundle string has the same length matching regular expression. If translation program 50 determines more than one resource bundle string has the same length matching regular expression, more than one resource bundle string is a potential match. In other embodiments, translation program 50 determines if more than one resource bundle string is a potential match by utilizing approximate string matching and regular expressions in conjunction. If translation program 50 determines that more than one resource bundle strings are not potential matches, processing proceeds down the “No” branch to step 255.

If translation program 50 determines that more than one resource bundle string are potential matches, processing proceeds down the “Yes” branch to step 250. In step 250, translation program 50 assigns weighted values to the resource bundle strings that are potential matches. In one embodiment, translation program 50 assigns weighted values to the resource bundle strings that are potential matches to further refine the results. In one embodiment, translation program 50 assigns relative weighted values to the resource bundle strings based on text in the vicinity of the received text. For example, for log files, translation program 50 gathers contextual information of text in the immediate vicinity of received text from log file 110. In another example, for screenshots, translation program 50 gathers contextual information of text that is located within a user interface container (e.g. dialog box). In one embodiment, text within the vicinity of the received text may have the same context as the received text. For example, strings within a dialog box may be contiguous within the resource bundle.

In one embodiment, translation program 50 assigns a weighted value to potential corresponding resource bundle string matches based on the distance between the potential corresponding resource bundle string of the received text and the resource bundle string of the text in the vicinity of the potential corresponding resource bundle string of the received text. To assign weighted values, translation program 50 assigns weighted values to the strings that are inversely proportional to the distance of the strings within the resource bundle. For example, the shorter the distance between the potential corresponding resource bundle string of the received text and the resource bundle string of the text in the vicinity of the potential corresponding resource bundle string of the received text, the higher the weighted value translation program 50 assigns to the potential corresponding resource bundle string. In one embodiment, the weightings may be indicative of the distance strings are stored in the resource bundle string. For example, a high weighing indicates strings in close proximity in the resource bundle.

In one embodiment, translation program 50 selects the potential corresponding resource bundle string with the highest weighted value as the resource bundle string translation program 50 will translate, provided no more than one resource bundle string has the highest weighted value. In one embodiment, weight values are a method of ranking more than one resource bundle string to select the correct resource bundle string(s). If more than one resource bundle string has the highest weighted value, translation program 50 selects both strings for translation, allowing the user to decide which string may be correct. For example, a user takes a screenshot of a message that says, “La liste requiert au moins 2 elements.” Translation program 50 determines several resource bundle strings, with the same Levenshtein distance, are the closest matches to “La liste requiert au moins 2 elements.” To further refine the results to find a correct match, translation program 50 assigns weighted values to the strings based on text within the vicinity of “La liste requiert au moins 2 elements.” The message “Erreur lors de la suppression des elements” appears in the screenshot near “La liste requiert au moins 2 elements.” The following strings are in the resource bundle in adjacent entries: “UI.OrderedSelectionChooser.MinRequiredViolation.Title=Erreur lors de la suppression des elements” and “UI.OrderedSelectionChooser.MinRequiredViolation.Message=La liste requiert au moins {0} elements.” The distance between the two adjacent strings is small. Therefore, translation program 50 assigns “UI.OrderedSelectionChooser.MinRequiredViolation.Message=La liste requiert au moins {0} elements.” a high weighted value. In one embodiment, translation program 50 selects the potential corresponding resource bundle string based on a confidence score. For example, if a confidence score was lower than the determined threshold, translation program 50 does not display the string. If a resource bundle string has a high confidence, translation program 50 displays the string if it has the highest confidence score.

In one embodiment, translation program 50 assigns weighted values to the potential corresponding resource bundle strings based on the name of the resource bundle key of the potential corresponding resource bundle string. Typically, keys with similar names are related. In one embodiment, translation program 50 assigns a higher weighted value the more similar (e.g. based on their Levenshtein distance) the name between two resource bundle keys. For example, “UI.OrderedSelectionChooser.MinRequiredViolation.Title” and “UI.OrderedSelectionChooser.MinRequiredViolation.Message” are keys with similar names. Translation program 50 assigns a high weighted value since there is a small distance between the keys. In one embodiment, translation program 50 assigns weighted values by combining approaches. For example, translation program 50 determines the distance between strings based on string names and how far apart the strings are stored in the resource bundle.

In step 255, translation program 50 identifies the resource bundle key. Translation program 50 identifies the resource bundle key using the matching template string or exact matching string. For example, <resource-bundle-key>=<resource-bundle-string>is the format of a key-value pair. By identifying the resource bundle string, translation program 50 identifies the corresponding resource bundle key. In one embodiment, translation program 50 identifies the corresponding resource bundle key of a resource bundle string that is an exact match. A resource bundle string that is an exact match does not include template text. For example, translation program 50 determines the string “Vous pouvez specifier un fichier valide.” from a French resource bundle is an exact match. Translation program 50 searches the French resource bundle for the “Vous pouvez specifier un fichier valide.” resource bundle string. When translation program 50 identifies the “Vous pouvez specifier un fichier valide.” resource bundle string, translation program 50 identifies the corresponding resource bundle key to the “Vous pouvez specifier un fichier valide.” resource bundle string. “export.file.missing” is the resource bundle key that corresponds to the “Vous pouvez specifier un fichier valide.” resource bundle string.

In one embodiment, translation program 50 identifies the corresponding resource bundle key of a resource bundle string that includes template text. If there is only one potential match that includes template text, translation program 50 identifies the corresponding resource bundle key based on the selected resource bundle string. For example, “{0} esiste gia. Sostituirlo?” is a template string that is the only potential match. “export.file.exists.message={0} esiste gia. Sostituirlo?” is the key-value pair that is associated with the “{0} esiste gia. Sostituirlo?” template string. Translation program 50 identifies “export.file.exists.message” as the corresponding resource bundle key to the template string.

In one embodiment, translation program 50 identifies and selects a resource bundle key for translation when more than one resource bundle string may be a possible match. In one embodiment, translation program 50 selects the closest matching resource bundle string and identifies and selects the corresponding resource bundle string for translation. Translation program 50 identifies the closest matching resource bundle string based on algorithms and scores and/or weights generated. In one embodiment, if translation program 50 cannot decide which resource bundle string is the closer match, translation program 50 selects both corresponding resource bundle keys for translation.

In step 260, translation program 50 translates the corresponding resource bundle string(s). Translation program 50 uses the resource bundle key from the resource bundle of the receive text to identify the corresponding resource bundle key in the resource bundle of the language that translation program 50 will translate the text to. For example, the received text is in French. A user wants translation program 50 to translate the received text into English. The received text is an exact match. Translation program 50 identifies the French resource bundle key of the received text. Translation program 50 searches the English resource bundle for the corresponding English resource bundle key. Translation program 50 locates the corresponding English resource bundle key and resource bundle string. Translation program 50 displays the English text in UI 80.

In one embodiment, translation program 50 translates text from a template string match. Translation program 50 identifies the corresponding resource bundle key in the resource bundle of the language the received text is in. Translation program 50 searches for the corresponding resource bundle key in the resource bundle of the language the user desires the received text to be translated to. Translation program 50 locates the corresponding resource bundle key and template resource bundle string in the resource bundle of the desired language for translation. Translation program 50 translates the text into the desired language and inserts the substitution substring, exactly as written when the text was received, in place of the substitution parameter. Translation program 50 displays the text in UI 80. In one embodiment, translation program 50 inserts the substitution substring exactly as it was received. For example, translation program 50 translates Spanish text to English. “azul” is the substitution substring. Translation program 50 inserts the Spanish substitute substring, “azul”, into the corresponding English template string.

In another example, a user wants translation program 50 to translate text from Italian to English. Translation program 50 selects “{0} esiste gia. Sostituirlo?” as the matching template string. “{0}” is the substitution parameter value in the template string. “/myfile” is the substitution substring that replaces the substitution parameter value. “export.file.exists.message” is the key for the template string. Translation program 50 identifies the corresponding resource bundle key in the English resource bundle, which also identifies the template resource bundle string. “{0} already exists. \nDo you want to replace it?” is the corresponding English template string. Translation program 50 replaces the substitution parameter with the Italian substitution substring. “/myfile already exists. \nDo you want to replace it?” is the template string with the substitution substring inserted in place of the substitution parameter. Translation program 50 displays in UI 80 “myfile already exists. Do you want to replace it?” to the user in UI 80.

In one embodiment, translation program 50 displays more than one resource bundle string to allow the user to decide which is the correct. In one embodiment, translation program 50 creates a translated log file. In one embodiment, translation program 50 annotates the received screenshot. In other embodiments, translation program 50 creates translated screenshots. Processing ends when translation is completed.

FIG. 3 depicts a block diagram of components of server 30 and client computing device 40 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Server 30 and client computing device 40 may each include communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Translation program 50, OCR program 60, data repository 70, and user interface UI 80 may each be stored in persistent storage 308 of server 30 and in memory 306 of server 30 for execution and/or access by one or more of the respective computer processors 304 via cache 316. UI 100, log file 110, and client program 120 may each be stored in persistent storage 308 of client computing device 40 and in memory 306 of client computing device 40 for execution and/or access by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Translation program 50, OCR program 60, data repository 70, and UI 80 may be downloaded to persistent storage 308 of server 30 through communications unit 310 of server 30. UI 100, log file 110, and client program 120 may each be downloaded to persistent storage 308 of client computing device 40 through communications unit 310 of client computing device 40.

I/O interface(s) 312 allows for input and output of data with other devices that may be connected to server 30 or client computing device 40. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., Translation program 50, optical character recognition program 60, data repository 70, and UI 80 can be stored on such portable computer readable storage media and can be loaded onto persistent storage 308 of server 30 via I/O interface(s) 312 of server 30. I/O interface(s) 312 also connect to a display device 320. Software and data used to practice embodiments of the present invention, e.g., UI 100, log file 110, and client program 120 can be stored on such portable computer readable storage media and can be loaded onto persistent storage 308 of client computing device 40 via I/O interface(s) 312 of client computing device 40. I/O interface(s) 312 of client computing device 40 or server 30 also connects to a display device 320.

Display device 320 provides a mechanism to display data to a user and may be, for example, a computer monitor, such as display 90 of client computing device 40.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for translating text into another language, the method comprising:
receiving, by one or more processors, text in a first language;
comparing, by one or more processors, the text to a plurality of resource bundle strings in the first language;
determining, by one or more processors, that the text at least partially matches two or more resource bundle strings of the plurality of resource bundle strings;
determining, by one or more processors, a resource bundle key corresponding to each resource bundle string of the two or more resource bundle strings;
ranking, by one or more computer processors, the determined resource bundle strings; and
translating, by one or more processors, the text from the first language to a second language using the determined resource bundle key corresponding to a resource bundle string, of the two or more resource bundle strings, with a highest ranking.

2. The method of claim 1, wherein the text is in a screenshot.

3. The method of claim 2, further comprising, prior to comparing, by one or more processors, the text to a plurality of resource bundle strings in the first language, converting the text in the screenshot to machine-encoded text.

4. (canceled)

5. (canceled)

6. (canceled)

7. The method of claim 1, wherein the text includes at least one variable.

8. The method of claim 7, further comprising, prior to comparing, by one or more processors, the text to a plurality of resource bundle strings in the first language, replacing the at least one variable with a placeholder.

9. The method of claim 8, wherein:
translating, by one or more processors, the text from the first language to a second language using one determined resource bundle key comprises:
translating, by one or more processors, the text from the first language to a second language, disregarding the placeholder, using one determined resource bundle key comprises translating; and
replacing the placeholder with the variable after the translating.

10. A computer program product for translating text into another language, the computer program product comprising:
one or more computer readable storage media, program instructions stored on the one or more computer readable storage media, the program instructions comprising:
program instructions to receive text in a first language;
program instructions to compare the text to a plurality of resource bundle strings in the first language;
program instructions to determine that the text at least partially matches two or more resource bundle strings of the plurality of resource bundle strings;
program instructions to determine a resource bundle key corresponding to each resource bundle string of the two or more resource bundle strings;
program instructions to rank the two or more resource bundle strings; and
program instructions to translate the text from the first language to a second language using the determined resource bundle key corresponding to a resource bundle string, of the two or more resource bundle strings, with a highest ranking.

11. The computer program product of claim 10, wherein the text is in a screenshot.

12. The computer program product of claim 11, wherein, prior to the program instructions to compare the text to a plurality of resource bundle strings in the first language, program instructions to convert the text in the screenshot to machine-encoded text.

13. (canceled)

14. (canceled)

15. (canceled)

16. The computer program product of claim 10, wherein the text includes at least one variable.

17. The computer program product of claim 16, further comprising, prior to the program instructions to compare the text to a plurality of resource bundle strings in the first language, program instructions, stored on the one or more computer readable storage media, to replace at least one variable with a placeholder.

18. The computer program product of claim 17, wherein the program instructions to translate the text from the first language to a second language using one determined resource bundle key comprise program instructions to:
translate the text from the first language to a second language, disregarding the placeholder, using one determined resource bundle key comprises translating; and
replace the placeholder with the variable after the translating.

19. A computer system for translating text into another language, the computer system comprising:
one or more computer processors;
one or more computer readable storage media; and
program instructions stored on the computer readable storage media for execution by at least one of the one or more processors, the program instructions comprising:
program instructions to receive text in a first language;
program instructions to compare the text to a plurality of resource bundle strings in the first language;
program instructions to determine that the text at least partially matches two or more resource bundle strings of the plurality of resource bundle strings;
program instructions to determine a resource bundle key corresponding to each resource bundle string of the two or more resource bundle strings;
program instructions to rank the two or more resource bundle strings; and
program instructions to translate the text from the first language to a second language using the determined resource bundle key corresponding to a resource bundle string, of the two or more resource bundle strings, with a highest ranking.

20. (canceled)

21. The computer program system of claim 19, wherein the text is in a screenshot.

22. The computer program system of claim 21, wherein, prior to the program instructions to compare the text to a plurality of resource bundle strings in the first language, program instructions to convert the text in the screenshot to machine-encoded text.

23. The computer program system of claim 19, wherein the text includes at least one variable.

24. The computer program system of claim 23, further comprising, prior to the program instructions to compare the text to a plurality of resource bundle strings in the first language, program instructions, stored on the one or more computer readable storage media for execution by at least one of the one or more processors, to replace at least one variable with a placeholder.

25. The computer program system of claim 24, wherein the program instructions to translate the text from the first language to a second language using one determined resource bundle key comprise program instructions to:
translate the text from the first language to a second language, disregarding the placeholder, using one determined resource bundle key comprises translating; and
replace the placeholder with the variable after the translating.
